(19) United States
(12) Patent Application Publication
(10) Pub. No.: US 2010/0197447 A1
(43) Pub. Date: Aug. 5, 2010

(54) CONTINUOUSLY VARIABLE TRANSMISSION

(76) Inventors: Brian Donohoe, Lancashire (GB); Philip Duncan Winter, Lancashire (GB); John William Edward Fuller, Lancashire (GB)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/528,080

(22) PCT Filed: Feb. 7, 2008
(86) PCT No.: PCT/GB2008/050077

§ 371 Date: Apr. 5, 2010

(30) Foreign Application Priority Data
Feb. 21, 2007 (GB) 0703353.3

(51) Int. Cl. F16H 61/664

(52) U.S. Cl. 476/2

(57) ABSTRACT

The invention concerns an arrangement for control of a continuously variable transmission. The transmission includes a variator (10) having a movable torque transfer part (rollers 18) whose position corresponds to a variator drive ratio. A hydraulic actuator (28) is arranged to exert an adjustable force on the torque transfer part. The transmission further comprises a flow control arrangement which is arranged to receive as control inputs (a) the current position of the torque transfer part and (b) a demanded position for it. The demanded position may for example be determined by driver input. The flow control arrangement is adapted to supply through a supply outlet which communicates with the hydraulic actuator a flow of fluid which is modulated in accordance with an error between the two control inputs. The flow of fluid increases with increasing error. A relief passage (110) leads from the said outlet to a pressure sink and is constricted so that fluid flow through it results in a pressure at the hydraulic actuator which is greater than that of the sink by an amount which corresponds to the rate of flow through the relief passage. The result is a mode of control of the transmission which possesses some of the advantages of both torque and ratio control.

The present invention relates to continuously variable transmissions, and particularly to an arrangement for controlling a variator in such a transmission.

Within a continuously variable transmission is a device having a rotary input, a rotary output, and some mechanism for transferring rotary drive from one to the other at a steplessly variable drive ratio. Such a device will be referred to herein as a “variator”.

Some form of control must be exercised over the variator and two particular modes of control are known the art.

Some variators are controlled to provide a specified ratio. The ratio may be directly set by a driver, or may be determined by an electronic controller, but in either case there is some signal, be it mechanical or electronic, which corresponds to a demanded variator ratio, and some mechanism for adjusting the actual variator ratio to match the demand. So-called “half toroidal” rolling traction type variators, for example, often have a hydraulic control system incorporating a comparator valve which receives inputs indicative of (a) the current inclination of variator rollers, which corresponds to the current variator ratio, and (b) a demanded variator ratio, set by associated electronics. In response to its inputs, the comparator valve modulates a hydraulic pressure applied to an actuator to move the variator rollers to one side or another of a neutral point, causing the rollers to steer themselves to bring the variator a ratio to the demanded value. The effect is to provide closed loop control over variator ratio. This type of control, involving setting a demanded ratio and adjusting the variator provide it, will be referred to as “ratio control”.

Some variators are able to provide a specified torque. The torque demand is typically provided by an electronic controller. A well known example is the full toroidal rolling traction type variator supplied by Torotrak (Development) Limited. In this device, variator rollers run upon, and serve to transfer drive between, semi-toroidally recessed variator input and output races. The rollers are able to move back and forth along a circumferential path about the races' common axis. Movement along this path causes the rollers to steer themselves to a new orientation, and so produces a change in variator drive ratio. Hence there is a predetermined relationship between the rollers' position and their inclination, a feature not shared with the half toroidal type of variator. The rollers are subject to (a) a controlled force from a hydraulic actuator and (b) a force due by the action of the races upon the rollers. The latter force is proportional to the variator “reaction torque”, defined as the sum of the torques acting on the input and output races (i.e. the sum of the variator's input and output torques, or equivalently the net torque acting upon the variator, which must of course be reacted to its mountings). In this system, by setting the hydraulic actuator's force, the variator reaction torque is directly set. Variator ratio is then not directly controlled. Speed changes taking place at the variator's input and output are automatically accommodated by the variator, whose ratio changes as necessary, without need of any control input, in accordance with such changes.

This type of control, involving setting a demanded variator torque and allowing the variator ratio to vary in accordance with resultant speed changes at its input and output, will be referred to as “torque control”.

Both modes of control have certain advantages. Ratio control can be implemented in a simple way, and even in a hydromechanical system lacking any electronic controller. Torque control, however, allows the transmission automatically to adjust itself to accommodate external influences. Consider for example the case of a construction vehicle such as a “front loader”, having a front-mounted scoop, being used to move a mound of earth from one place to another. The vehicle will be driven into the mound of earth to fill the scoop, and will rapidly be brought to a halt. In a ratio controlled transmission, if the engine is not disengaged at this point (e.g. by declutching, if a clutch is provided) the result must be an engine stall. In a torque controlled transmission, particularly one which is capable of providing “geared neutral” (infinite speed reduction), the ratio can automatically change to accommodate the vehicle's deceleration, without any driver input.

The present invention is intended to make available advantageous aspects of both torque and ratio control in a single transmission.

In accordance with a the present invention, there is a continuously variable transmission comprising a variator having a movable torque transfer part whose position corresponds to a variator drive ratio and a hydraulic actuator arranged to exert an adjustable force on the torque transfer part, the transmission further comprising a flow control arrangement which is arranged to receive as control inputs (a) the current position of the torque transfer part and (b) a demanded position of the torque transfer part, and which is adapted to supply through a supply outlet which communicates with the hydraulic actuator a flow of fluid which is modulated in accordance with an error between the two control inputs, so that the flow of fluid increases with increasing error, a relief passage leading from the said outlet to a pressure sink, the relief passage being constricted so that fluid flow through it results in a pressure at the hydraulic actuator which is greater than that of the sink by an amount which corresponds to the rate of flow through the relief passage.

The invention can provide a mode of control which has some of the advantages of both torque and ratio control. A demanded variator ratio (corresponding to a demanded position of the torque control part) is set, and the transmission tends to adopt this ratio. However the ratio is able to deviate from the demanded value under the influence of externally applied wheel torques (as for example when the vehicle is brought up against a mound of earth, in the example above, or when it is going uphill). The further the ratio deviates from the demanded value, the larger is the wheel torque exerted by the transmission tending to reduce the deviation.

Specific embodiments of the present invention will now be described, by way of example, only, with reference to the accompanying drawings, in which:—

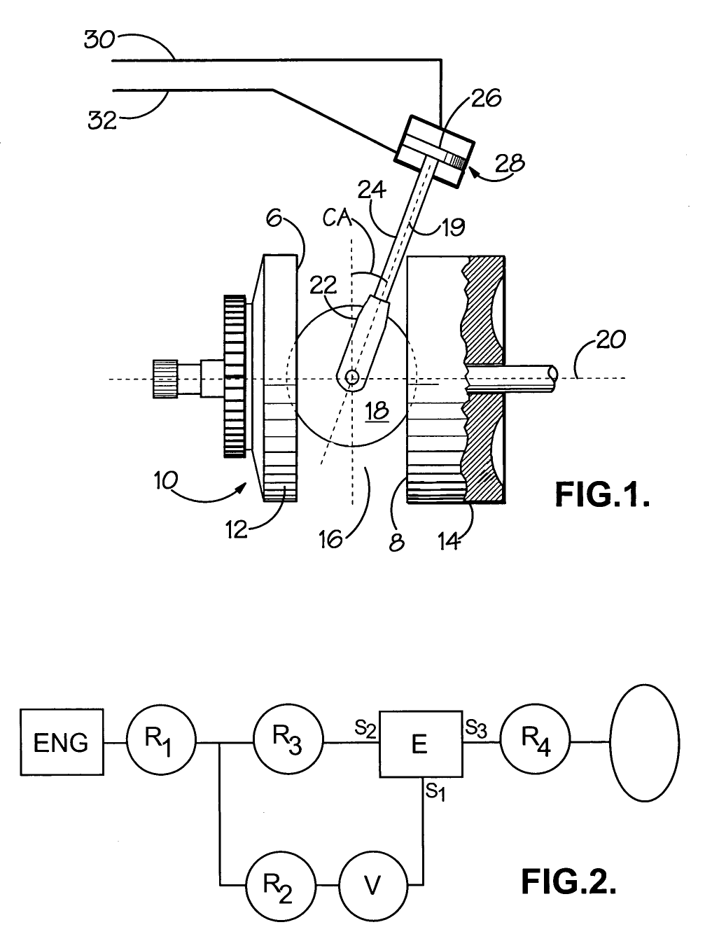

FIG. 1 is a highly simplified representation of a variator suitable for use in implementing the present invention;

FIG. 2 is a schematic representation of a CVT suitable for use in implementing the present invention; and

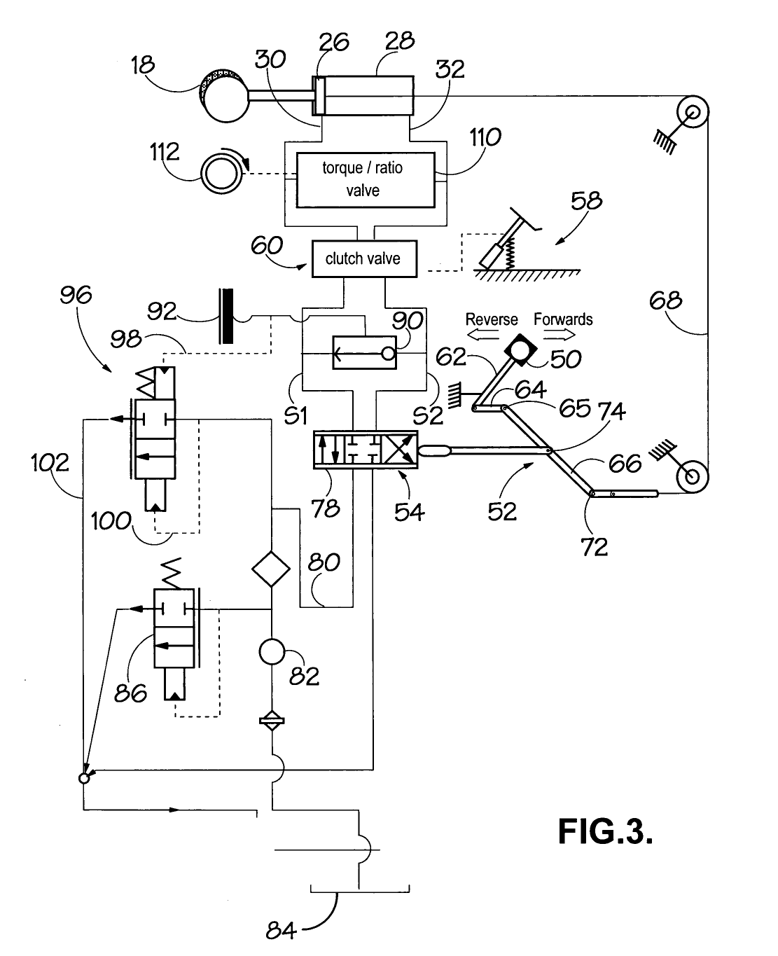

FIG. 3 is a schematic representation of a control system embodying the present invention.

FIG. 1 represents a variator of the well known full toroidal, rolling traction type. The present invention has been developed in connection with a CVT using this type of variator, which is particularly well suited to the purpose, but in principle variators of other types could be used. The variator 10 comprises co-axially mounted input and output races 12, 14, adjacent faces 6, 8 of which are semi-toroidally recessed and together define a generally toroidal cavity 16 containing a movable torque transfer part in the form of a roller 18. In fact a practical variator typically has two or three such rollers spaced about the cavity 16 at circumferential intervals. Each roller 18 runs upon the faces 6, 8 of the respective races 12, 14 and so serves to transmit drive from one to the other. The roller 18 is able to move back and forth along a circumferential direction about the common axis 20 of the races 12, 14. It is also able to precess. That is, the roller's axis is able to turn, changing the inclination of the roller axis to the disc axis. In the illustrated example, these motions are provided for by rotatably mounting the roller 18 in a carrier 22 coupled by stem 24 to a piston 26 of an actuator 28. A line 19 from the centre of the piston 26 to the centre of the roller 18 constitutes a precession axis about which the whole assembly can burn. Precession of the roller results in changes of the radii of the paths traced upon the races 12, 14 by the roller, and hence in a change of variator drive ratio.

Note that in this example the precession axis 19 does not lie precisely in a plane perpendicular to the common axis 20, but is instead inclined to this plane. The angle of inclination is labelled CA in the drawing, and is known as the “castor angle”. As the roller moves back and forth it follows a circular path centred upon the common axis 20. Furthermore the action of the races 12, 14 upon the roller creates a steering moment which tends to maintain it at such an inclination that the roller axis intersects the common axis 20. This intersection of the axes can be maintained, despite movement of the roller back and forth along its circular path, by virtue of the castor angle. As the roller moves along its path, it is also steered by the action of the races, causing it to precess such as to maintain the intersection of the axes. The result is that the position of the roller along its path corresponds to a certain roller inclination and hence to a certain variator drive ratio.

The actuator 28 receives opposed hydraulic fluid pressures through supply lines 30, 32. The force thus created by the actuator 28 urges the roller along its circular path about the common axis 20, and at equilibrium it is balanced by forces exerted upon the roller by the races 12, 14. The force exerted by the races is proportional to the sum of the torques externally applied to the variator races. This sum—the variator input torque plus the variator output torque—is the net torque that must be reacted to the variator's mountings, and is referred to as the reaction torque.

Looking now at FIG. 2, an engine is represented by a box ENG, the variator by a circle V and an epicyclic shunt gear by a box E. The variator input is coupled to the engine through gearing R1, R2. Its output is coupled to a first input shaft S1 of the epicyclic shunt E. A second input shaft S2 of the epicyclic shunt E is coupled through fixed ratio gearing R1, R3 to the engine. An output shaft S3 of the epicyclic shunt E is coupled through gearing R4 to the point of power usage, in this case wheels W of a motor vehicle. The operation and construction of epicyclic gearing is very well known, and is not depicted herein. The speed of the output shaft S3 can be expressed as a function of the speeds of the input shafts S1, S2. At some variator drive ratio, the speeds of S1 and S2 cancel each other out and the output speed at S3 is zero whatever the speed of the engine. This is the “geared neutral” condition referred to above. Variator drive ratios to one side of geared neutral produce S3 output rotation in one direction and variator drive ratios to the other side of geared neutral produce S3 output rotation in the opposite direction.

Thus by adjusting the variator drive ratio, it is possible to move from forward drive, through geared neutral to reverse.

A control arrangement embodying the present invention will now be described with reference to FIG. 3, in which the variator's control actuator and piston are once more labelled 28 and 26 respectively. The arrangement serves to control the hydraulic pressures applied to the actuator 28 through the supply lines 30, 32 to control the variator.

A user operable ratio control part is seen at 50 in the drawing. The ratio control part is operatively coupled to the variator rollers. The user moves this part to control the ratio adopted by the variator and hence by the transmission as a whole. The variator ratio is a function of the position of the ratio control part. The ratio control part is movable through a continuous range, indicated by arrows in the drawing, from a maximum forward ratio position through a geared neutral position to a maximum reverse ratio position. The range of ratios in forward and reverse will typically be different, making higher outputs speeds available in forward than in reverse. The ratio control part is in this embodiment formed by a hand lever. It could alternatively be a pedal. Pedal mechanisms are known in which the driver, using both the ball and heel of the foot, can rock the pedal to either side of a neutral position. These would be well suited in this context, but an alternative would be to give the driver two pedals—one for forward drive and one for reverse.

The device used to operatively couple the ratio control part to the variator rollers is seen in the drawing and is hydro-mechanical. To briefly summarise its main components, it uses a comparator arrangement 52 which receives and compares (a) the position of the ratio control part 50 and (b) the position of the variator rollers 18, and in response modulates a force to move the rollers toward the position dictated by the user through the ratio control part 50. This force is provided through a hydraulic roller control arrangement 54 supplying fluid pressure to the actuator 28. The user is provided with a torque release control 58 which, acting through a torque release device 60, serves to operatively decouple the ratio control part 50 from the variator and so to reduce or even to zero variator reaction torque, thereby providing functionality which is in some ways similar to that provided by a clutch in a convention manual transmission. The user is also provided with a control 112 for adjusting the performance of the transmission, as will be explained below.

These aspects will now be described in more detail, beginning with the comparator arrangement 52.

In the present embodiment the comparator uses a system of mechanical levers. The lever forming the ratio control part 50 is pivoted about a fixed fulcrum 62 and extends beyond the fulcrum to a pivotal link with a bridging part 64, which in turn has a first pivotal comparator linkage 65 to a comparator bar 66. Hence moving the ratio control part 50 moves the comparator bar's first comparator linkage 65.

The piston 26 is coupled to a second comparator linkage 72 of the comparator bar. Any number of suitable mechanisms for this purpose could be devised, but in the present embodiment this coupling is made through a cable 68, such as a Bowden cable, capable of applying force in both directions. Hence the position of the second comparator linkage 72 corresponds to the position of the variator roller 18, and so to the variator ratio.

Between the first and second comparator linkages 65, 72, the comparator bar 66 has a reference linkage 74 to a valve control bar 76 leading in turn to a variator control valve 78. The effect of the comparator arrangement 52 is to set the state of the variator control valve 78 on the basis of a comparison of variator ratio against the position of the ratio control part 50.

The variator control valve 78 forms part of the roller control arrangement 54. It has a port which receives pressurised fluid through fluid line 80 from a pump 82. The pump 82 draws from a sump 84 and is provided with a relief valve 86. The variator control valve 78 has ports communicating with two supply lines S1, S2 arranged to supply fluid respectively to opposite sides of the variator piston 26. Pressure in S1 urges the piston 26 one way. Pressure in S2 urges it the other way. The variator control valve 78 is a proportional valve with three states. In one, it applies pressurised fluid from the pump 82 to S1. In another it applies the fluid to S2. In the third, intermediate, state, it isolates S1 and S2 from the pump.

Consider what happens when, the system having been in a state of equilibrium, the user moves the ratio control part 50. This produces a mismatch between the control part's position and the variator ratio. The first comparator linkage 65 is moved. In this example, let us take it the movement is to the left as viewed. The reference linkage 74 is thus also moved leftward, causing the variator control valve 78 to adopt its second state, applying pump pressure to S2 and venting S1 to the sump. Resultant pressure on piston 26 urges it to the left, as viewed, moving the piston and changing variator ratio. This motion is transmitted through the cable linkage 68, moving the second comparator linkage to the right. When this rightward motion of the second comparator linkage is sufficient to cancel out the leftward motion of the first comparator linkage, the variator control valve 78 returns to its third position to maintain the piston pressure and position.

This is in effect a servo system for control of roller position using hydraulic actuation and mechanical position feedback.

Turning now to the torque release control 58, this may for example be a hand lever or foot pedal. By use of the control 58, the driver is able to reduce and even set to zero the force applied to the variator rollers. In this way variator reaction torque is likewise set to zero, and the variator is rendered incapable of sustaining an output torque to drive the vehicle wheels. The effect is akin to declutching in a conventional manual transmission, in that it prevents the transmission from applying torque to the vehicle wheels, but is achieved without any physical decoupling of the engine from the wheels. Instead it relies upon operatively decoupling the variator rollers from the ratio control part 50. The torque release control part 58 acts upon a torque release device 60 formed in this embodiment as a torque release valve leading from one fluid supply line S1 to the other S2. When open, it provides a route for equalisation of pressures in the supply lines S1 and S2. With little or no pressure difference across the piston, no significant force is applied to the variator rollers and so no significant reaction torque can be sustained. Closing the torque release valve 60 restores reaction torque. The valve 60 is a proportional valve so that the user can adjust its degree of opening, and in this way set intermediate values of reaction torque, the effect again being much like the progressive release of a clutch pedal in a conventional manual transmission.

The torque release control can be used analogously to the type of launch device described above, by first setting the ratio control part 50 to demand forward or reverse drive and then progressively closing the torque release valve 60 to bring the ratio in a controlled manned to the demanded value, causing the vehicle to accelerate away from rest. The torque release control can be used to gently “inch” the vehicle toward a desired position, as when parking. In this case it serves to limit the wheel torque, again in a manner very much akin to the conventional clutch. The torque release control can also be used to release any creep torque, e.g. when the vehicle is parked with the engine running. Note however that the user can also control the transmission without use of this control. For example, he/she can “shuttle” from forward to reverse and vice versa using only the ratio control part 50.

FIG. 3 also shows a higher pressure wins valve arrangement 90 which serves to connect whichever of the supply lines S1, S2 is at higher pressure to an end load actuator 92 whose function is to urge the variator races 12, 14 together, as is well known in the art.

The illustrated circuit is configured to provide where possible a constant pressure drop across the variator control valve 78. In the illustrated embodiment, this is achieved by means of a forward pressure control valve 96 whose state is controlled by two opposed pilot pressure signals. The first of these is taken through a line 98 from the higher pressure wins valve arrangement 90, and so corresponds to the higher of the pressures in S1 and 82. The second is taken through a line 100 connected to the pump output and so corresponds to the pump output pressure. In the illustrated example, the pilot pressure signals are applied to opposite ends of the valve's spool. In response to its pilot signals, the forward pressure control valve 96 selectively opens and closes a relief line 102 leading to the sump. Hence it serves to compare the input and output pressures of the variator control valve 78, and in response to vent the input pressure as necessary to provide a constant pressure drop across the variator control valve 78. As a result, the flow of fluid supplied through the variator control valve (i.e. the volume of fluid supplied per unit time) varies as a function of the opening of this valve, and hence as a function of variator ratio error. More specifically it is substantially proportional to the error in the roller position. To appreciate why, note first of all that the variator control valve 78 is a proportional valve—that is, its through-flow cross section increases with increasing spool displacement. Hence as roller position error increases, this cross section correspondingly increases and a greater flow is needed to maintain the pressure drop across the valve.

In accordance with the present invention, the illustrated circuit further incorporates a constricted passage for exhausting fluid flow from the high pressure line S1/S2. In the illustrated embodiment the constricted passage 110 is connected between the two supply lines S1 and S2, so that fluid flows through it from the higher pressure line to the lower pressure line. An optional feature found in the present embodiment is that the constriction of the passage 110 is adjustable, to provide a variable relationship between flow rate through it and pressure across it. In this example the driver is provided with a control such as a dial 112 which is mechanically coupled to an adjustable orifice in the constricted passage 110 to vary its cross section. The orifice can be closed altogether, to prevent flow through the constricted passage 110. A sharp edged orifice is used in the present embodiment, since its pressure/flow characteristic is affected only slightly by changes in fluid viscosity (e.g. with changes in temperature, as the transmission warms up in use). Other types of constriction could however be used in the passage to provide a desired pressure/flow characteristic.

When the constricted passage 110 is closed, and the torque release valve 60 is also closed, the illustrated system provides ratio control. The user sets a ratio demand through the ratio control part 50 and the rollers are moved to the corresponding positions by the roller control arrangement 54 and comparator 52. Unless pump capacity is exceeded, the hydraulics will prevent ratio form deviating significantly from the demanded value. Consider again the example of a “front loader” construction vehicle being driven into a mound of earth. Such a vehicle having the illustrated transmission, operated in this condition, would most probably suffer an engine stall as the earth brought it to a halt.

However, consider how the system's function is modified when a constricted opening is provided for flow through the passage 110. Flow entering the lines S1/S2 due to a ratio error can then pass through the orifice, allowing ratio to deviate from the demanded value. However flow through the orifice creates a pressure difference across it, so that the rollers continue to be subject to a force tending to reduce ratio error. As explained above, flow into S1/S2 increases with increasing ratio error. Hence the pressure drop across constricted passage 110 likewise increases with ratio error, and a relationship is established between ratio error and the differential pressure across the pistons 26, and hence the variator's output torque. Adjusting the opening of constricted passage 110 allows this relationship to be changed. A large opening provides a lower output torque for a given ratio error.

In the example of a front loader being driven into a mound of earth, the variator will now automatically down-shift, in response to the increased wheel torque, as the vehicle comes to a halt. Torque multiplication from engine to wheels is increased and engines tall can be a voided. Moving the ratio control part 5 then serves to adjust ratio error and hence wheel torque, rather than transmission ratio.

The above described embodiment serves as an example only of a possible implementation of the present invention. Numerous other ways of putting the invention into practice are possible. As an example, the lever arrangement used to compare roller position and demanded ratio could be replaced by a well known type of valve in which the spool and sleeve are movable by the rollers and the ratio control part.

1. A continuously variable transmission comprising:
a variator having a movable torque transfer part whose position corresponds to a variator drive ratio and a hydraulic actuator arranged to exert an adjustable force on the torque transfer part, the transmission further comprising a flow control arrangement which is arranged to receive as control inputs (a) the current position of the torque transfer part and (b) a demanded position of the torque transfer part, and which is adapted to supply through a supply outlet which communicates with the hydraulic actuator a flow of fluid which is modulated in accordance with an error between the two control inputs, so that the flow of fluid increases with increasing error, a relief passage leading from the said outlet to a pressure sink, the relief passage being constricted so that fluid flow through it results in a pressure at the hydraulic actuator which is greater than that of the sink by an amount which corresponds to the rate of flow through the relief passage.

2. A continuously variable transmission as claimed in claim 1 in which the flow control arrangement comprises a variator control valve controlling a connection between a pump and the said supply outlet, and a pressure control valve which selectively exhausts pump pressure to maintain a constant pressure drop across the variator control valve.

3. A continuously variable transmission as claimed in claim 2 further comprising a mechanical comparator which receives mechanical inputs corresponding to the current position of the torque transfer part and to a demanded position of the torque transfer part, and which provides to the variator control valve a mechanical output corresponding to the error between the two.

4. A continuously variable transmission as claimed in claim 3 in which the comparator comprises:
a lever having first comparator linkage which is mechanically coupled to a control movable by the driver to indicate the demanded position of the torque transfer part,
a second comparator linkage which is coupled to the torque transfer part, and
a reference linkage which is between the first and second comparator linkages and which is coupled to the pressure control valve.

5. A continuously variable transmission as claimed in claim 1 in which the constriction of the relief passage is adjustable.

6. A continuously variable transmission as claimed in claim 1 in which the cross section of the relief passage is adjustable by the driver.

7. A continuously variable transmission as claimed in claim 5 in which the relief passage is able to be closed.

8. A continuously variable transmission as claimed in claim 1 in which the variator is of the type which creates a reaction torque corresponding to the force applied by the hydraulic actuator.

9. A continuously variable transmission as claimed in claim 1 in which the variator is a toroidal race type, the movable torque transfer part being a variator roller running upon semi-toroidally recessed variator races.

10. A continuously variable transmission as claimed in claim 1 in which the hydraulic actuator is a double acting piston and cylinder device arranged to, and in which the flow control arrangement has two outlets for selectively supplying the flow of fluid to one side of the piston and the other.

11. A continuously variable transmission as claimed in claim 10 in which the relief passage leads from one side of the piston to the other, so that the lower pressure side of the piston serves as the pressure sink.

12. (canceled)
